(19) United States
(12) Patent Application Publication
(10) Pub. No.: US 2023/0187740 A1
(43) Pub. Date: Jun. 15, 2023

(54) POUCH-TYPE ALL-SOLID-STATE BATTERY WITH REFERENCE ELECTRODE INSERTED AND METHOD FOR MANUFACTURING THE SAME

(71) Applicants: Hyundai Motor Company, Seoul (KR); Kia Corporation, Seoul (KR)

(72) Inventors: Yong Guk GWON, Hwaseong-si (KR); Ju Min KIM, Hwaseong-si (KR); Jae Ho SHIN, Seoul (KR); Ga Young CHOI, Busan (KR); Yong Seok CHOI, Seoul (KR); Min Sun KIM, Goyang-si (KR)

(73) Assignees: Hyundai Motor Company, Seoul (KR); Kia Corporation, Seoul (KR)

(21) Appl. No.: 18/077,507

(22) Filed: Dec. 8, 2022

(30) Foreign Application Priority Data
Dec. 15, 2021 (KR) 10-2021-0179570

(51) Int. Cl. H01M 50/105; H01M 50/178

(52) U.S. Cl. CPC H01M 50/105; H01M 50/178; H01M 2004/028

(57) ABSTRACT

The present disclosure relates to a pouch-type all-solid-state battery with a reference electrode inserted and a method for manufacturing the same. The pouch-type all-solid-state battery with a reference electrode inserted includes a unit cell including a negative electrode portion, a positive electrode portion, and a solid electrolyte portion interposed between the negative electrode portion and the positive electrode portion and having a sheet shape; an exterior material provided with a space capable of accommodating the unit cell therein; a reference electrode tap adjacent to the solid electrolyte portion, and formed inside the exterior material; and a reference electrode portion positioned between the solid electrolyte portion and the reference electrode tap, and formed inside the unit cell.

### CROSS-REFERENCE TO RELATED APPLICATION

This application claims under 35 U.S.C. § 119(a) the benefit of priority to Korean Patent Application No. 10-2021-0179570 filed on Dec. 15, 2021 in the Korean Intellectual Property Office, the entire contents of which are incorporated herein by reference.

### TECHNICAL FIELD

The present disclosure relates to a pouch-type all-solid-state battery with a reference electrode inserted and a method for manufacturing the same.

### BACKGROUND

A typical cell is a two-electrode cell including a positive electrode and a negative electrode, and properties of the cell are evaluated by measuring properties of the positive electrode, a working electrode, with the negative electrode, a counter electrode, as a reference electrode. In other words, the two-electrode cell only measures voltage and resistance of the whole cell, and is not able to figure out detailed properties of the positive electrode and the negative electrode.

A three-electrode cell is a cell including a positive electrode, a negative electrode and a reference electrode, and is capable of measuring voltage, resistance and the like of the positive electrode and the negative electrode in comparison with the reference electrode. In other words, voltage, resistance and the like of the positive electrode and the negative electrode themselves may be separated from voltage, resistance and the like of the whole cell, and analyzed. Accordingly, detailed properties for each component inside the cell are readily figured out.

Analyzing potential curve and detailed resistance is essential in order to manufacture an all-solid-state battery with high capacity and energy density. An all-solid-state battery with a three-electrode cell is a useful means to analyze potential curve, detailed resistance, reaction and the like of a positive electrode and a negative electrode.

### SUMMARY

An object of the present disclosure is to provide an all-solid-state battery including a reference electrode and having a pouch cell form.

An object of the present disclosure is to establish a condition for properly driving a pouch-type all-solid-state battery including a reference electrode.

An object of the present disclosure is to provide a method for manufacturing a reference electrode satisfying the above-mentioned condition.

The objects of the present disclosure are not limited to the objects mentioned above, and other objects of the present disclosure not mentioned may be understood by the following description, and are clearer from embodiments of the present disclosure. In addition, the objects of the present disclosure may be realized by means and combinations thereof described in the claims.

A pouch-type all-solid-state battery with a reference electrode inserted for accomplishing the objects of the present disclosure described above includes the following constitutions.

One embodiment of the present disclosure provides a pouch-type all-solid-state battery with a reference electrode inserted, the battery comprising a unit cell comprising a negative electrode portion, a positive electrode portion, and a solid electrolyte portion interposed between the negative electrode portion and the positive electrode portion and having a sheet shape; an exterior material provided with a space capable of accommodating the unit cell therein; a reference electrode tap adjacent to the solid electrolyte portion, and formed inside the exterior material; and a reference electrode portion positioned between the solid electrolyte portion and the reference electrode tap, and formed inside the unit cell.

In addition, there is provided a pouch-type all-solid-state battery with a reference electrode inserted, wherein an area of the negative electrode portion is the same as or larger than an area of the positive electrode portion.

In addition, there is provided a pouch-type all-solid-state battery with a reference electrode inserted, wherein the solid electrolyte portion comprises a first coating layer formed on the negative electrode portion; and a second coating layer formed on the first coating layer and under the positive electrode portion, and one end of the reference electrode portion is positioned between the first coating layer and the second coating layer.

In addition, there is provided a pouch-type all-solid-state battery with a reference electrode inserted, wherein the reference electrode portion has a thickness (A) of about 10 μm to 50 μm, and the thickness (A) of the reference electrode portion and a thickness (B) of the solid electrolyte portion after pressurization satisfy the following Relation Formula 1.

B/2≥A [Relation Formula 1]

In addition, there is provided a pouch-type all-solid-state battery with a reference electrode inserted, wherein a shortest distance (C) between the positive electrode portion or the negative electrode portion and the reference electrode portion and the thickness (B) of the solid electrolyte portion after pressurization satisfy the following Relation Formula 2.

B/2≥C≥1 μm [Relation Formula 2]

In addition, there is provided a pouch-type all-solid-state battery with a reference electrode inserted, wherein the shortest distance (C) between the positive electrode portion or the negative electrode portion and the reference electrode portion is from about 10 μm to 120 μm.

A method for manufacturing a pouch-type all-solid-state battery with a reference electrode inserted according to one embodiment of the present disclosure may comprise installing a unit cell, in which a negative electrode portion, a solid electrolyte portion having a sheet shape and a positive electrode portion are consecutively laminated, on an inner surface of an exterior material, the reference electrode portion installed on the solid electrolyte portion; sealing the exterior material; and pressurizing the result.

In addition, the pressurizing may be isotropically pressurizing at a pressure of 300 MPa or greater.

In addition, the solid electrolyte portion comprises a first coating layer formed on the negative electrode portion; and a second coating layer formed on the first coating layer and under the positive electrode portion, and the installing of the reference electrode portion on the solid electrolyte portion may comprise installing the first coating layer; aligning a position of the reference electrode portion on the first coating layer; and installing the second coating layer on the first coating layer so as to surround at least a part of the reference electrode portion.

According to the present disclosure, a reference electrode portion is positioned to be formed inside a unit cell, which is effective in enhancing accuracy in potential separation and resistance separation of a negative electrode portion and a positive electrode portion.

According to the present disclosure, various analyses such as a direct current-internal resistance measurement method (hereinafter, DC-IR) and electrochemical impedance spectroscopy (hereinafter, EIS) can be conducted on the negative electrode portion and the positive electrode portion, which enables detailed resistance analyses in actual cell circumstances.

According to the present disclosure, a more accurate EIS value can be measured by adjusting a distance between the reference electrode portion and the measured electrode portion to be short.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 illustrates a pouch-type all-solid-state battery with a reference electrode inserted as one embodiment of the present disclosure.

FIG. 2 is a side view illustrating a unit cell of the pouch-type all-solid-state battery with a reference electrode inserted as one embodiment of the present disclosure.

FIG. 3 is a side view illustrating a solid electrolyte portion and a reference electrode portion of the pouch-type all-solid-state battery with a reference electrode inserted as one embodiment of the present disclosure.

FIG. 4 is a first reference diagram for describing a method for manufacturing a pouch-type all-solid-state battery with a reference electrode inserted according to the present disclosure.

FIG. 5 is a second reference diagram for describing a method for manufacturing a pouch-type all-solid-state battery with a reference electrode inserted according to the present disclosure.

FIG. 6 is a third reference diagram for describing a method for manufacturing a pouch-type all-solid-state battery with a reference electrode inserted according to the present disclosure.

FIG. 7 shows a result of measuring potential fluctuation of a pouch-type all-solid-state battery with a reference electrode inserted according to each of Example 1 and Comparative Example 1.

FIG. 8A shows a result of measuring impedance resistance separation of a pouch-type all-solid-state battery with a reference electrode inserted according to Comparative Example 1.

FIG. 8B shows a result of measuring impedance resistance separation of a pouch-type all-solid-state battery with a reference electrode inserted according to Example 1.

FIG. 9 shows a result of measuring an EIS value of a pouch-type all-solid-state battery with a reference electrode inserted according to each of Example 1 and Comparative Example 1.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, the dimensions of the structures are illustrated after being enlarged than the actual dimensions for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise” or “have” are intended to designate that a feature, number, step, operation, component, part, or combinations thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” another part, this includes not only the case where it is “directly on” the another part but also the case where there is still another part therebetween. Conversely, when a part of a layer, film, region, plate, etc. is said to be “under” another part, this includes not only the case where it is “directly under” the another part, but also the case where there is still another part therebetween.

Unless otherwise specified, all numbers, values, and/or expressions expressing quantities of components, reaction conditions, polymer compositions and formulations used in the present specification are approximate values obtained by reflecting various uncertainties of the measurement that arise in obtaining these values among others in which these numbers are essentially different. Therefore, they should be understood as being modified by the term “about” in all cases. As used herein, the term “about” means modifying, for example, lengths, degrees of errors, dimensions, the quantity of an ingredient in a composition, concentrations, volumes, process temperature, process time, yields, flow rates, pressures, and like values, and ranges thereof, refers to variation in the numerical quantity that may occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. Whether modified by the term “about” the claims appended hereto include equivalents to these quantities. The term “about” further may refer to a range of values that are similar to the stated reference value. In certain embodiments, the term “about” refers to a range of values that fall within 10, 9, 8,7, 6, 5,4, 3, 2, 1 percent above or below the numerical value (except where such number would exceed 100% of a possible value or go below 0%) or a plus/minus manufacturing/measurement tolerance of the numerical value. Further, when a numerical range is disclosed in this description, such a range is continuous, and includes all values from a minimum value of such a range to a maximum value including the maximum value, unless otherwise indicated. Furthermore, when such a range refers to an integer, such a range includes all integers including from a minimum value to a maximum value including the maximum value, unless otherwise indicated.

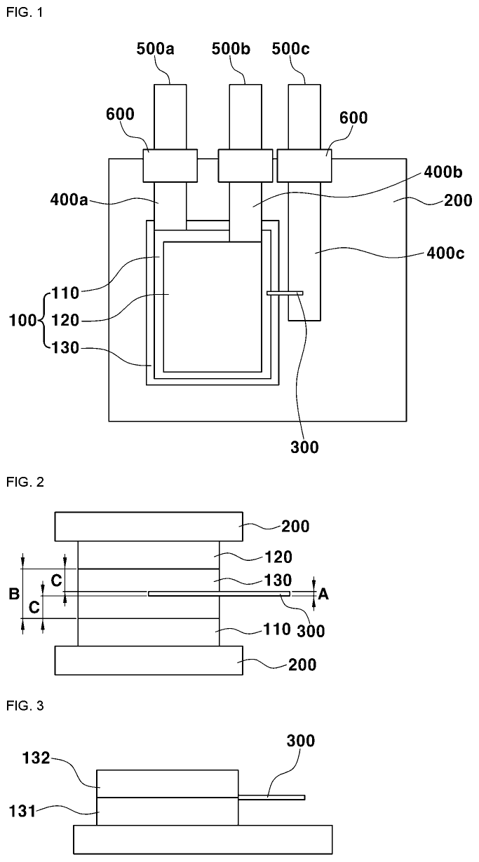

FIG. 1 illustrates a pouch-type all-solid-state battery with a reference electrode inserted as one embodiment of the present disclosure. Referring to FIG. 1, the all-solid-state battery includes a unit cell 100, and an exterior material 200 provided with a space capable of accommodating the unit cell 100 therein.

The unit cell 100 includes a negative electrode portion 110, a positive electrode portion 120, and a solid electrolyte portion 130 interposed between the negative electrode portion 110 and the positive electrode portion 120 and having a sheet shape.

One embodiment of the present disclosure may include a reference electrode tap 400c adjacent to the solid electrolyte portion 130 and formed inside the exterior material 200, and a reference electrode portion 300 positioned between the solid electrolyte portion 130 and the reference electrode tap 400c and formed inside the unit cell 100.

FIG. 2 is a side view illustrating the unit cell 100 of the pouch-type all-solid-state battery with a reference electrode inserted as one embodiment of the present disclosure.

An area of the negative electrode portion 110 may be the same as or larger than an area of the positive electrode portion 120.

A reference electrode portion 300 may be positioned on one inner side surface of the solid electrolyte portion 130. More specifically, referring to FIG. 2, the reference electrode portion 300 may be formed to the center on the side surface of the solid electrolyte portion 130.

A shortest distance between the positive electrode portion 120 and the reference electrode portion 300 may be from about 10 μm to 120 μm. In addition, a shortest distance between the negative electrode portion 110 and the reference electrode portion 300 may be from about 10 μm to 120 μm. Specifically, based on the side view as in FIG. 2, a shortest distance from any one point of the edges of the positive electrode portion 120 to any one point of the edges of the reference electrode portion 300 may be from about 10 μm to 120 μm. The reference electrode portion 300 needs to be apart from the positive electrode portion 120 by 10 μm or greater in order not to be in contact with the positive electrode portion 120 even when the reference electrode portion 300 spreads by pressurization. Meanwhile, when the reference electrode portion 300 is apart from the positive electrode portion 120 by greater than 120 μm, resistance increases, failing to properly measure signals of each electrode portion 110, 120, and the all-solid-state battery may unnecessarily become larger.

In addition, based on the side view as in FIG. 2, a shortest distance from any one point of the edges of the negative electrode portion 110 to any one point of the edges of the reference electrode portion 300 may be from about 10 μm to 120 μm. The reference electrode portion 300 needs to be apart from the negative electrode portion 110 by 10 μm or greater in order not to be in contact with the negative electrode portion 110 even when the reference electrode portion 300 spreads by pressurization. Meanwhile, when the reference electrode portion 300 is apart from the negative electrode portion 110 by greater than 120 μm, resistance increases, failing to properly measure signals of each electrode portion 110, 120, and the all-solid-state battery may unnecessarily become larger.

The all-solid-state battery may further include a negative electrode tap 400a electrically connected to the negative electrode portion 110 and accommodated in the exterior material 200, a positive electrode tap 400b electrically connected to the positive electrode portion 120 and accommodated in the exterior material 200, and a reference electrode tap 400c electrically connected to the reference electrode portion 300 and accommodated in the exterior material 200.

The all-solid-state battery may further include a negative electrode lead 500a electrically connected to the negative electrode tap 400a and extending to the outside by passing through the exterior material 200, a positive electrode lead 500b electrically connected to the positive electrode tap 400b and extending to the outside by passing through the exterior material 200, and a reference electrode lead 500c electrically connected to the reference electrode tap 400c and extending to the outside by passing through the exterior material 200.

A sealing portion 600 may be disposed at parts where the negative electrode lead 500a, the positive electrode lead 500b and the reference electrode lead 500c pass through the exterior material 200 to maintain the exterior material 200 in a sealed state.

The present disclosure aims to suggest, when using a reference electrode portion 300 in a pouch-type all-solid-state battery, specific conditions under which the reference electrode portion 300 is properly operated. For reference, one of the above-mentioned conditions is the distance between the reference electrode portion 300 and the positive electrode portion 120 described above.

FIG. 3 is a plane view illustrating the unit cell 100 of the pouch-type all-solid-state battery.

Referring to FIG. 3, the solid electrolyte portion 130 according to one embodiment of the present disclosure includes a first coating layer 131 formed on the negative electrode portion 110 and a second coating layer 132 formed on the first coating layer 131 and under the positive electrode portion 120, and the reference electrode portion 300 may be formed to be positioned on one end between the first coating layer 131 and the second coating layer 132.

The first coating layer 131 may be formed on the negative electrode portion 110 in FIG. 2. The second coating layer 132 may be formed on the first coating layer 131 and under the positive electrode portion 120. The reference electrode portion 300 may be positioned on one end between the first coating layer 131 and the second coating layer 132. More preferably, one end of the reference electrode portion 300 may be positioned between the first coating layer 131 and the second coating layer 132, and the other end may be positioned on the reference electrode tap 400c.

A thickness (A) of the reference electrode portion 300 and a thickness (B) of the solid electrolyte portion 130 after pressurization described below may mean a thickness in a height direction based on the side view of FIG. 2. In addition, the shortest distance (C) between the positive electrode portion 120 or the negative electrode portion 110 and the reference electrode portion 300 may mean a distance value in a height direction based on the side view of FIG. 2.

The thickness (A) of the reference electrode portion 300 may be from about 10 μm to 50 μm. As one embodiment, the reference electrode portion 300 may be a metal wire or metal foil, or a lithiated wire or lithiated foil. The thickness (A) of the reference electrode portion 300 and the thickness (B) of the solid electrolyte portion 130 after pressurization may satisfy the following Relation Formula 1. The thickness of the solid electrolyte portion 130 may be a sum of the thicknesses of the first coating layer 131 and the second coating layer 132. The thickness (B) of the solid electrolyte portion 130 after pressurization may be smaller than the thickness of the solid electrolyte portion 130 before pressurization.

B/2≥A [Relation Formula 1]

As one embodiment, the thickness (A) of the reference electrode portion 300 may be from about 10 μm to 50 μm, and the thickness of the first coating layer 131 and the second coating layer 132 before pressurization may be from 30 μm to 100 μm. Herein, the thickness (B) of the solid electrolyte portion 130 after pressurization may be from 30 μm to 100 μm.

When the thickness (A) of the reference electrode portion 300 is ½ or greater of the thickness (B) of the solid electrolyte portion 130 after pressurization, the reference electrode portion 300 is exposed on the surface of the solid electrolyte portion 130, resulting in being brought into contact with the surface of the negative electrode portion 110 or the positive electrode portion 120, which makes it impossible to perform a role as the reference electrode portion 300.

Meanwhile, in the all-solid-state battery, the shortest distance (C) between the positive electrode portion 120 or the negative electrode portion 110 and the reference electrode portion 300 and the thickness (B) of the solid electrolyte portion 130 after pressurization may satisfy the following Relation Formula 2.

B/2≥C≥1 μm [Relation Formula 2]

The shortest distance (C) between the positive electrode portion 120 or the negative electrode portion 110 and the reference electrode portion 300 may be a factor for determining accuracy of EIS measurement. Accuracy of EIS measurement increases as the distance between the reference electrode portion 300 and the measured electrode portion decreases. Herein, the EIS may be more accurately measured when the distance between the reference electrode portion 300 and the measured electrode portion and the thickness (B) of the solid electrolyte portion 130 after pressurization satisfy the following Relation Formula 2.

The shortest distance (C) between the negative electrode portion 110 and the reference electrode portion 300 may mean, assuming that the negative electrode portion 110 and the reference electrode portion 300 are positioned on the same plane, a shortest distance from one end of the reference electrode portion 300 side of the negative electrode portion 110 to one end of the negative electrode portion 110 side of the reference electrode portion 300. Likewise, the shortest distance (C) between the positive electrode portion 120 and the reference electrode portion 300 may mean, assuming that positive electrode portion 120 and the reference electrode portion 300 are positioned on the same plane, a shortest distance from one end of the reference electrode portion 300 side of the positive electrode portion 120 to one end of the positive electrode portion 120 side of the reference electrode portion 300.

A method for manufacturing an all-solid-state battery according to the present disclosure may include a step of installing a unit cell 100, in which a negative electrode portion 110, a solid electrolyte portion 130 having a sheet shape and a positive electrode portion 120 are consecutively laminated, on an inner surface of an exterior material 200, wherein installing the reference electrode portion 300 on the solid electrolyte portion 130; a step of sealing the exterior material 200; and a step of pressurizing the result.

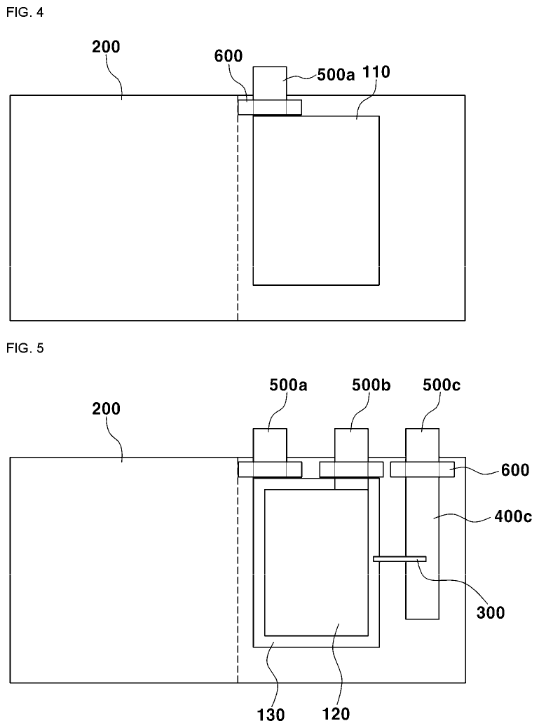

First, the unit cell 100 described above may be installed on an inner surface of the exterior material 200 as in FIG. 4. Herein, together with the unit cell 100, a negative electrode tap 400a and a negative electrode lead 500a may be installed to fit each electrode. In addition, a sealing portion 600 may be disposed at a position where the negative electrode lead 500a touches the exterior material 200.

Next, as in FIG. 5, a positive electrode tap 400a and a positive electrode lead 500b may be installed to fit each electrode together with the unit cell 100. In addition, a sealing portion 600 may be disposed at a position where the positive electrode lead 500b touches the exterior material 200.

In addition, a reference electrode tap 400c and a reference electrode lead 500c may be installed together with the unit cell 100. In addition, a sealing portion 600 may be disposed at a position where the reference electrode lead 500c touches the exterior material 200.

The reference electrode portion 300 may be formed over at least a part of the reference electrode tap 400c and the inside of the solid electrolyte portion 130. As one embodiment, the reference electrode portion 300 may be formed to be positioned at a center portion in a thickness direction of the solid electrolyte portion 130 to be connected to the reference electrode tap 400c.

The step of installing of the reference electrode portion 300 on the solid electrolyte portion 130 may include steps of installing the first coating layer 131, aligning a position of the reference electrode portion 300 on the first coating layer 131, and installing the second coating layer 132 on the first coating layer 131 so as to surround at least a part of the reference electrode portion 300.

Next, the exterior material 200 may be sealed. As one embodiment, the exterior material 200 may be vacuum sealed and cut.

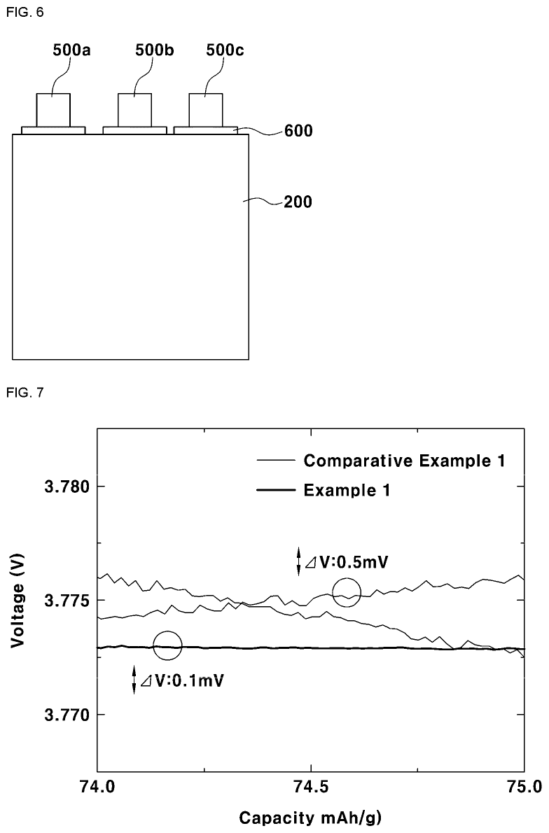

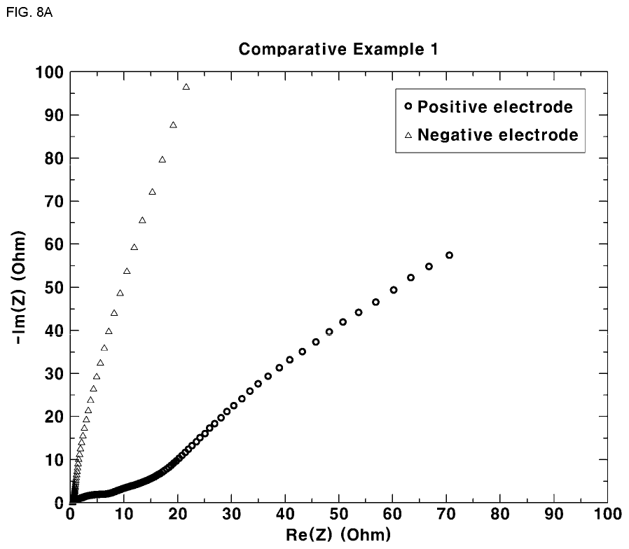

Lastly, the unit cell 100 may be pressurized as in FIG. 6. Through the pressurization, interfaces between the negative electrode portion 110, the positive electrode portion 120 and the solid electrolyte portion 130 may be evenly formed.

The pressurization may be isotropically pressurizing at a pressure of 300 MPa or greater. When the pressure of the pressurization is less than 300 MPa, interfaces between each constitution of the unit cell 100 may not be favorably formed.

Hereinafter, the present disclosure will be described more specifically through Examples. The following Examples are just examples to help understand the present disclosure, and the scope of the present disclosure is not limited thereto.

### EXAMPLE 1

A pouch-type all-solid-state battery was manufactured in order to verify the conditions of Relation Formula 2 described above. As the reference electrode portion 300, an aluminum wire was used. The shortest distance (C) between the positive electrode portion 120 and the reference electrode portion 300 was adjusted to 10 μm. In addition, the shortest distance (C) between the negative electrode portion 110 and the reference electrode portion 300 was adjusted to 10 μm.

The thickness (B) of the solid electrolyte portion 130 after pressurization was adjusted to 170 μm.

### COMPARATIVE EXAMPLE 1

The shortest distance (C) between the positive electrode portion 120 and the reference electrode portion 300, and the shortest distance (C) between the negative electrode portion 110 and the reference electrode portion 300 were adjusted to 100 μm, and the reference electrode portion 300 was positioned outside the unit cell 100 instead of inside. Furthermore, lithium foil-attached aluminum foil was used as the electrode portion 300 in Comparative Example 1. Other than these, a pouch-type all-solid-state battery was manufactured in the same manner as in Example 1.

### EXPERIMENTAL EXAMPLE 1

Potentials of the positive electrode portion 120, the negative electrode portion 110 and the whole cell of the pouch-type all-solid-state battery according to each of Example 1 and Comparative Example 1 were measured.

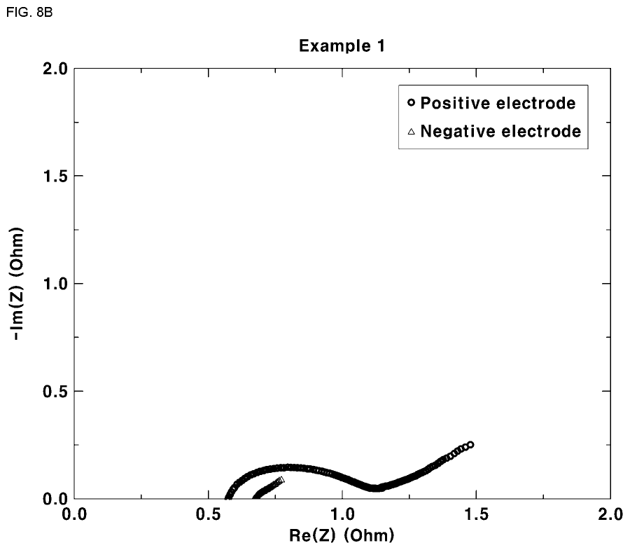

FIG. 7 shows the result of the pouch-type all-solid-state battery according to each of Example 1 and Comparative Example 1. It is seen that, in Example 1, only a potential fluctuation of about 0.1 mV was measured during the positive electrode potential measurement. On the other hand, it is seen that a potential fluctuation of about 0.5 mV was measured during the positive electrode potential measurement in Comparative Example 1.

FIG. 8A and FIG. 8B show the results of the pouch-type all-solid-state batteries according to Comparative Example 1 and Example 1, respectively. First, as for resistance of each electrode measured by DC-IR, the cell has resistance of −1.83 ohm, the positive electrode has resistance of −1.23 ohm and the negative electrode has resistance of −0.6 ohm. The resistance value measured by DC-IR and the resistance value measured by EIS need to have the same order value in order to enhance accuracy in resistance separation.

As in FIG. 8A, it is identified that both the positive electrode resistance and the negative electrode resistance had a different order in the resistance values in Comparative Example 1. On the other hand, as in FIG. 8B, it is identified that both the positive electrode resistance and the negative electrode resistance had the same order in the resistance values in Example 1.

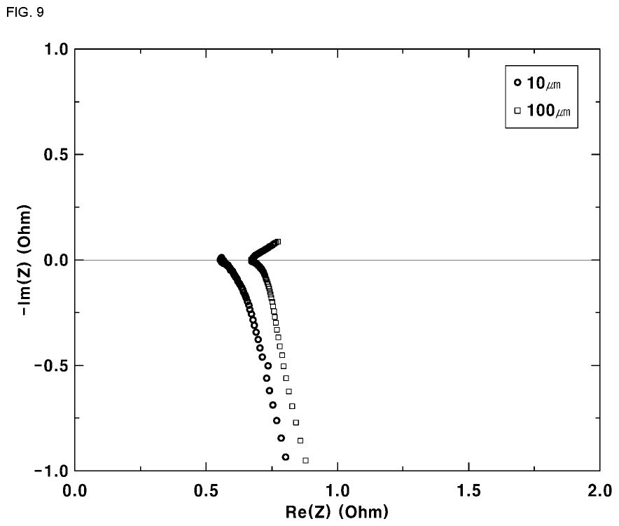

FIG. 9 shows the result of the pouch-type all-solid-state batteries according to Comparative Example 1 and Example 1. Accuracy of the EIS measurement decreases when farther than the criterion of Relation Formula 2, and when shorter than the criterion, possibility of a short phenomenon increases during the pressurization process required in the present disclosure.

In Comparative Example 1, the EIS open type appears as dots without drawing an arc, whereas the EIS open type shows relatively more accurate values while drawing an arc in Example 1.

Hereinabove, Experimental Examples and Examples of the present disclosure have been described in detail. However, the scope of a right of the present disclosure is not limited to the above-described Experimental Examples and Examples, and various changes and modifications made by those skilled in the art using the basic concept of the present disclosure defined in the appended claims also fall within the scope of a right of the present disclosure.

### EXPLANATION OF REFERENCE NUMERALS

100: Unit cell

110: Negative electrode portion

120: Positive electrode portion

130: Solid electrolyte portion

131: First coating layer

132: Second coating layer

200: Exterior material

300: Reference electrode portion

400a: Negative electrode tap

400b: Positive electrode tap

400c: Reference electrode tap

500a: Negative electrode lead

500b: Positive electrode lead

500c: Reference electrode lead

600: Sealing portion

What is claimed is:

1. A pouch-type all-solid-state battery with a reference electrode inserted, the battery comprising:
a unit cell comprising a negative electrode portion, a positive electrode portion, and a solid electrolyte portion interposed between the negative electrode portion and the positive electrode portion and having a sheet shape;
an exterior material provided with a space capable of accommodating the unit cell therein;
a reference electrode tap adjacent to the solid electrolyte portion, and formed inside the exterior material; and
a reference electrode portion positioned between the solid electrolyte portion and the reference electrode tap, and formed inside the unit cell.

2. The pouch-type all-solid-state battery with a reference electrode inserted of claim 1, wherein an area of the negative electrode portion is the same as or larger than an area of the positive electrode portion.

3. The pouch-type all-solid-state battery with a reference electrode inserted of claim 1, wherein the solid electrolyte portion comprises a first coating layer formed on the negative electrode portion; and
a second coating layer formed on the first coating layer and under the positive electrode portion, and
one end of the reference electrode portion is positioned between the first coating layer and the second coating layer.

4. The pouch-type all-solid-state battery with a reference electrode inserted of claim 1, wherein the reference electrode portion has a thickness (A) of about 10 μm to 50 μm, and
the thickness (A) of the reference electrode portion and a thickness (B) of the solid electrolyte portion after pressurization satisfy the following Relation Formula 1:
B/2≥A. [Relation Formula 1]

5. The pouch-type all-solid-state battery with a reference electrode inserted of claim 1, wherein a shortest distance (C) between the positive electrode portion or the negative electrode portion and the reference electrode portion and a thickness (B) of the solid electrolyte portion after pressurization satisfy the following Relation Formula 2:
B/2≥C≥1 μm. [Relation Formula 2]

6. The pouch-type all-solid-state battery with a reference electrode inserted of claim 1, wherein a shortest distance (C) between the positive electrode portion or the negative electrode portion and the reference electrode portion is from about 10 μm to 120 μm.

7. A method for manufacturing a pouch-type all-solid-state battery with a reference electrode inserted, the method comprising:
installing a unit cell, in which a negative electrode portion, a solid electrolyte portion having a sheet shape and a positive electrode portion are consecutively laminated, on an inner surface of an exterior material, the reference electrode portion installed on the solid electrolyte portion;
sealing the exterior material; and
pressurizing the result.

8. The method for manufacturing a pouch-type all-solid-state battery with a reference electrode inserted of claim 7, wherein an area of the negative electrode portion is larger than an area of the positive electrode portion.

9. The method for manufacturing a pouch-type all-solid-state battery with a reference electrode inserted of claim 7, wherein the pressurizing is isotropically pressurizing at a pressure of about 300 MPa or greater.

10. The method for manufacturing a pouch-type all-solid-state battery with a reference electrode inserted of claim 7, wherein a shortest distance (C) between the positive electrode portion or the negative electrode portion and the reference electrode portion is from about 10 μm to 120 μm.

11. The method for manufacturing a pouch-type all-solid-state battery with a reference electrode inserted of claim 7, wherein the solid electrolyte portion comprises a first coating layer formed on the negative electrode portion; and
a second coating layer formed on the first coating layer and under the positive electrode portion, and
the installing of the reference electrode portion on the solid electrolyte portion comprises installing the first coating layer;
aligning a position of the reference electrode portion on the first coating layer; and
installing the second coating layer on the first coating layer so as to surround at least a part of the reference electrode portion.

12. The method for manufacturing a pouch-type all-solid-state battery with a reference electrode inserted of claim 7, wherein the reference electrode portion has a thickness (A) of about 10 μm to 50 μm, and
the thickness (A) of the reference electrode portion and a thickness (B) of the solid electrolyte portion after pressurization satisfy the following Relation Formula 1:
B/2≥A. [Relation Formula 1]

13. The method for manufacturing a pouch-type all-solid-state battery with a reference electrode inserted of claim 7, wherein a shortest distance (C) between the positive electrode portion or the negative electrode portion and the reference electrode portion and a thickness (B) of the solid electrolyte portion after pressurization satisfy the following Relation Formula 2:
B/2≥C≥1 μm. [Relation Formula 2]
